(19) United States
(12) Patent Application Publication
(10) Pub. No.: US 2018/0236677 A1
(43) Pub. Date: Aug. 23, 2018

(54) LUBRICATION BOX WITH SUPPORT STRUCTURE

(71) Applicant: Edgewell Personal Care Brands, LLC., Chesterfield, MO (US)

(72) Inventor: ALAN BLATTER, Hamden, CT (US)

(21) Appl. No.: 15/751,129

(22) PCT Filed: Aug. 22, 2016
(86) PCT No.: PCT/US2016/048001

§ 371 Date: Feb. 7, 2018

Related U.S. Application Data
(60) Provisional application No. 62/206,514, filed on Aug. 18, 2015.

(51) Int. Cl. B26B 21/44

(52) U.S. Cl. CPC B26B 21/443; B26B 21/4018

(57) ABSTRACT

A lubrication box for a shaving cartridge has a body including an upper wall and a sidewall in combination defining a cavity. The upper wall has an aperture. A support structure is disposed within the cavity. The support structure has a plurality of support structure apertures that extend, directly or indirectly, from the upper wall aperture. A solid shaving aid material is disposed within the cavity, the shaving aid material at least partially filling the upper wall aperture and the support structure apertures. A lid is attached to the sidewall such that the cavity is substantially closed. The support structure can be integrally formed with the body or the support structure and body can be separate structures. The support structure apertures can be aligned with the upper surface aperture or can be relatively angled.

### BACKGROUND

### 1. Technical Field

The present disclosure is generally directed to a lubrication box for a wet shaving implement in general and, more particularly, to a support structure for lubrication material within the lubrication box.

### 2. Background Information

Wet shaving implements generally consist of a razor cartridge, also commonly known as a shaving cartridge, and a handle. The razor cartridge can be fixedly, or pivotally, attached to the handle. In addition, the razor cartridge might be affixed to the handle such that, after several uses, a user can replace a spent razor cartridge with a new razor cartridge on the same handle. Such handles and razor cartridges are often referred to as “system razors.” Alternatively, the razor cartridge can be affixed to the handle such that it is not intended to be removed from the handle during normal use and, once the razor cartridge is spent, the entire shaving implement is discarded and an entirely new shaving implement is used in the now-discarded shaving implements place. Such shaving implements are often referred to as “disposable razors.”

Proposals have been made to incorporate a shaving aid e.g., lubricant, whisker softener, razor cleanser, medicinal agent, cosmetic agent or combination thereof, into a razor cartridge, e.g., by depositing a shaving aid in a recess on the razor cartridge, by incorporating a shaving aid directly into one or more molded polymeric components of the razor cartridge, by adhesively securing a shaving aid composite to the razor cartridge, and by use of a mechanical connection between a shaving aid composite and the razor cartridge. A water soluble shaving aid, e.g., polyethylene oxide, has been dispersed in a matrix of a water insoluble material, e.g., a styrenic and/or an olefinic polymer, to form a skin engaging member also known as a shaving aid strip, a shaving aid composite, or a lubricating strip. The skin engaging member has been mounted in or on razor cartridge structures, adjacent the cutting edge or edges. Upon exposure to water, the water-soluble shaving aid leaches from the matrix of the skin engaging member onto the skin.

Other lubricating elements can comprise a so-called lubrication box that can be mounted on or adjacent to the razor cartridge structures. Exemplary lubrication boxes are described in commonly assigned U.S. Patent application publications 2011/0099815 and 2012/0023750, essential disclosures of which are incorporated herein for reference as described later in the present disclosure. Lubrication boxes can be found in a commercialized product sold under the trade name SCHICK HYDRO®. In these lubrication boxes, a shaving aid consisting essentially of a polymeric water soluble shaving aid is compacted, e.g. ultrasonically compacted, to provide a body of the shaving aid material. The shaving aid material body can be formed in-situ in an open body of a lubrication box structure or can be formed externally thereto and subsequently placed in the body. A lid closes the box. A wall of the lubrication box has a surface that engages a user's skin surface during normal use. This wall is perforated with a plurality of apertures to enable the shaving aid, when solubilized, to be deposited on the skin surface. A preferred shaving aid material is polyethylene oxide (PEO), in particular high molecular weight (e.g. about 5-8 million, based on rheological measurements) and blends of PEOs including high molecular weight PEO. Such PEO materials and blends have a tendency to swell when hydrated and the known lubrication boxes are provided with an air gap between the body of shaving aid material and lid to accommodate swelling. Such provision of a shaving aid can have a longer life than a shaving aid strip.

As the shaving aid material body solubilizes during use its longer life it can become detached from the box body structure and fall, partially or fully, into the air gap. The effectiveness of the body is reduced. Accordingly, it is an object of the present disclosure to provide a lubrication box with support structure to maintain the effectiveness and life expectancy of lubrication agents.

### SUMMARY

According to one aspect of the present disclosure, a lubrication box for a shaving cartridge comprises an upper wall of a body of the lubrication box. The upper wall has a skin-engaging surface and an upper wall aperture. At least one sidewall depends from the upper wall and the upper wall and the at least one sidewall in combination form a cavity. A support structure is disposed within the cavity. The support structure comprises a plurality of support structure apertures that extend, directly or indirectly, from the upper wall aperture. A body of solid shaving aid material is disposed within the cavity, the shaving aid material at least partially filling the upper wall aperture and the support structure apertures. A lid is attached to the sidewall such that the cavity is substantially closed.

In some aspects, a gap exists between in the cavity between the shaving aid material and the lid of the lubrication box to permit the shaving aid material to expand during normal use.

In some aspects, the body of the lubrication box and the support structure are integrally formed such that the support structure apertures extend directly from the upper wall aperture. In other aspects the body of the lubrication box and the support structure are separate structures and the support structure is in contact with an interior surface of the upper surface, opposite the skin-engaging surface, such that the support structure apertures extend directly from the upper wall aperture. In further aspects, the body of the lubrication box and the support structure are separate structures and the support structure is spaced from the interior surface of the upper surface such that the support structure apertures extend directly indirectly from the upper wall aperture. In some aspects the support structure apertures are axially aligned with the upper wall aperture and in other aspects the support structure apertures are angled relative to the upper wall aperture

In some aspects, the shaving aid material consists essentially of polyethylene oxide. In the context of the present disclosure, the term “consists essentially of” means that the shaving aid material can include trace impurities or trace ingredients such as colorants, perfumes, particulate exfoliants or skin care ingredients such as vitamin E or aloe.

In some aspects the shaving aid material can comprise one or more layers. Beneficially, in aspects where the support structure is spaced from the interior surface, it can be positioned at the boundary region between adjacent layers.

In combination, the upper wall aperture and support structure apertures provide increased contact surface area between the lubrication box and the shaving aid material body. Support of the shaving aid material body within the box is improved. This and other features and advantages of the present disclosure will be more fully understood with reference to the following detailed description when taken in conjunction with the accompanying drawings.

### BRIEF DESCRIPTION OF THE SEVERAL VIEWS OF THE DRAWINGS

FIG. 1 shows a perspective view of an exemplary razor cartridge including an embodiment of a lubrication box;

FIG. 2A shows a plan view of another embodiment of a lubrication box body;

FIG. 2B shows a plan view of a further embodiment of a lubrication box body;

FIG. 3A shows a schematic sectional view of an embodiment of a lubrication box taken along lines 3-3 of FIG. 1;

FIG. 3B shows a schematic sectional view of another embodiment of a lubrication box taken along lines 3-3 of FIG. 1;

FIG. 3C shows a schematic sectional view of a further embodiment of a lubrication box taken along lines 3-3 of FIG. 1; and

FIG. 4 shows another embodiment of the lubrication box of FIG. 3B.

### DETAILED DESCRIPTION

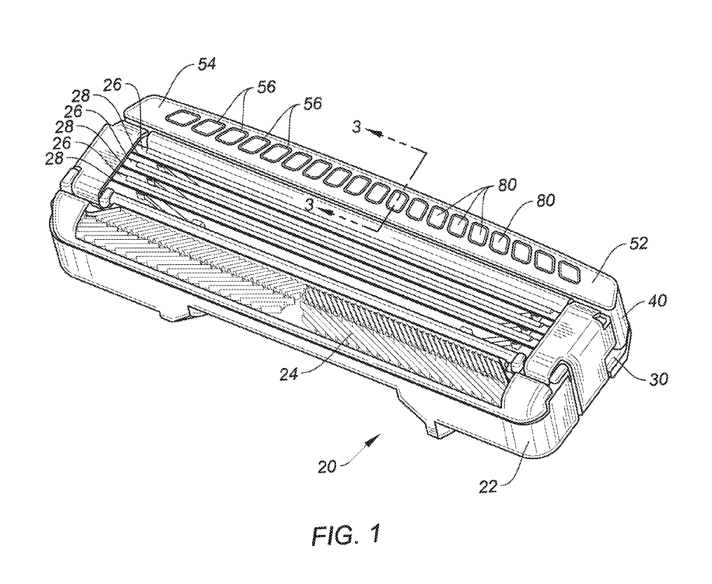

Referring to the figures and in particular to FIG. 1, a razor cartridge 20 is depicted. The razor cartridge 20 comprises a frame 22. The frame 22 preferably is manufactured by injection molding, e.g. multi-shot injection molding a suitable thermoplastic polymer such as an acrylonitrile butadiene styrene (ABS). This material is chosen for beneficial properties such as impact resistance in any accidental drop, dimensional stability and chemical resistance to many substances found in a typical wet shaving environment. Other suitable materials can also he chosen. The frame 22 has mounted therein one or more razor blades 26 having cutting edges 28. The frame 22 has a guard 24 in front of the blades. The guard 24 can comprise a plurality of flexible fins or other structure formed from a molded thermoplastic elastomeric material beneficially provided in the multi-shot injection molding process of the frame 22. The guard 24 generally stretches, flattens and otherwise prepares or stimulates the user's skin prior to the skin encountering the cutting edges 28. Guards 24 are well known in the art and will therefore not be discussed in detail further herein other than to point out that the present disclosure is not limited to being used with any particular type of guard 24.

A lubrication box 40 is mounted on a rearwardly extending shelf 30 of the frame 22. The present disclosure is not limited to this position and manner of mounting a lubrication box and other suitable positions and mounting methods are within the scope of the present disclosure. For example, the lubrication box can be mounted on a separable lubrication mechanism as disclosed in U.S. Pat. No. 8,191,263, the content of which is incorporated herein for reference to the method of mounting a lubrication box. The lubrication box can also be mounted in front of the blades or both in front of and behind the blades as disclosed in U.S. Patent application publications 2011/0099815 and 2012/0023750, the content of which is incorporated herein for reference to positions of mounting a lubrication box.

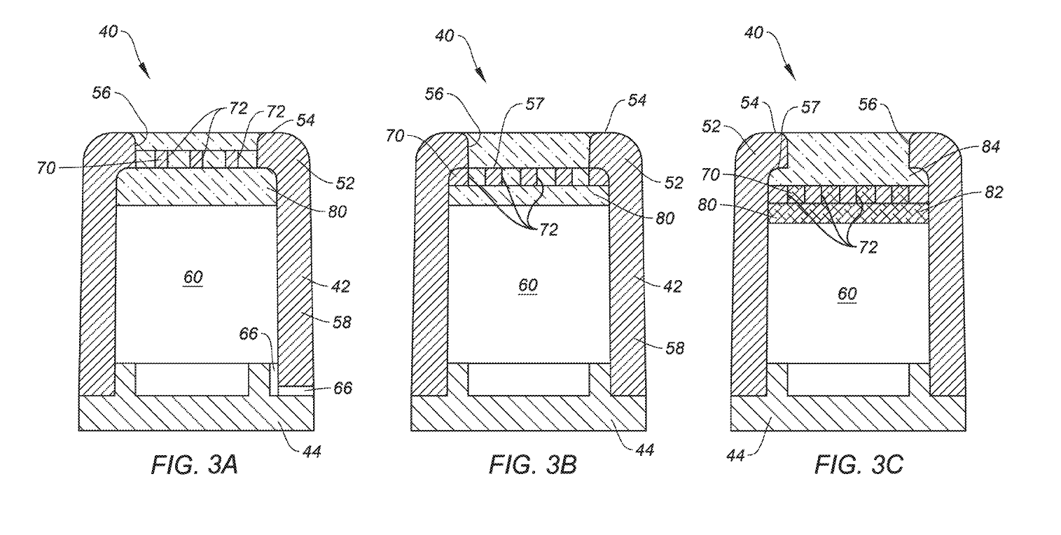

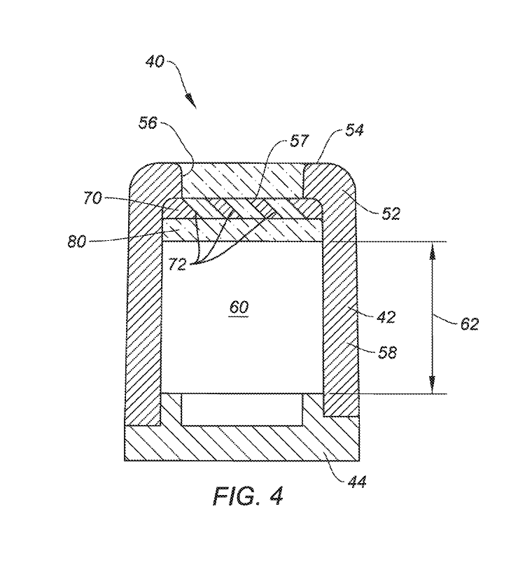

The lubrication box 40 has an upper wall 52 having an (outer) surface 54 provided to generally engage a user's skin during a normal wet shaving operation. The upper wall. 52 (and thus skin-engaging surface 54) has one or more upper wall apertures 56 (see FIGS. 3A-3C and 4).

Referring now to FIG. 3B, the lubrication box 40 has a body 42 and a lid 44. The body 42 has an upper wall 52 with an outer, skin-engaging surface 54 and an opposed interior surface 57. The body has a sidewall 58 depending from the upper wall 52. The upper wall 52 and sidewall 58 in combination define a cavity 60. The upper wall 52 has an aperture 56. A separate support structure 70 is within the cavity 60 and in contact with the interior surface 57. The support structure 70 has a plurality of support structure apertures 72. In FIG. 3B the support structure apertures 72 extend directly from an upper wall aperture 56 and are generally axially aligned with the upper wall aperture 56. A body of a solid shaving aid material 80 (described later in the present disclosure) is positioned within the cavity. 60. The shaving aid material 80 at least partially and preferably fully fills the upper wall aperture 56 and the support structure apertures 72.

Referring to FIG. 3A, the lubrication box 40 is generally similar to that of FIG. 3B with an exception that the support structure 70 is integrally formed with the body 42 of the lubrication box 40.

Referring to FIG. 3C, the lubrication box 40 is generally similar to that of FIG. 3B with a first exception that the support structure 70 is spaced from the interior surface 57 such that the support structure apertures 72 extend indirectly from the upper wall aperture 56. The support structure apertures 72 are generally axially aligned with the upper wall aperture 56. In FIG. 3C, optionally the shaving aid material 80 can comprise more than one layer, e.g. a first layer 84 and a second layer 82. As depicted, the shaving aid material 80 of the first layer 84 at least partially and preferably fully fills the upper wall aperture 56 and the shaving aid material 80 of the second layer 82 at least partially and preferably fully fills the support structure apertures 72. Such an embodiment can be manufactured by providing an empty body 42 of the lubrication box 40. A portion of shaving aid material that would comprise a first layer 84 is added to the empty body 42 and e.g. compacted therein as described later in the present disclosure. The support structure 70 is positioned on the first layer 84 of shaving aid material 80. A portion of shaving aid material that would comprise a second layer 82 is added and also compacted therein. A lid 44 is added as described later in the present disclosure.

Referring to FIG. 4, the lubrication box 40 is generally similar to that of FIG. 3B with an exception that the support structure apertures 72 extend directly from the upper wall aperture 56 but are relatively angled thereto.

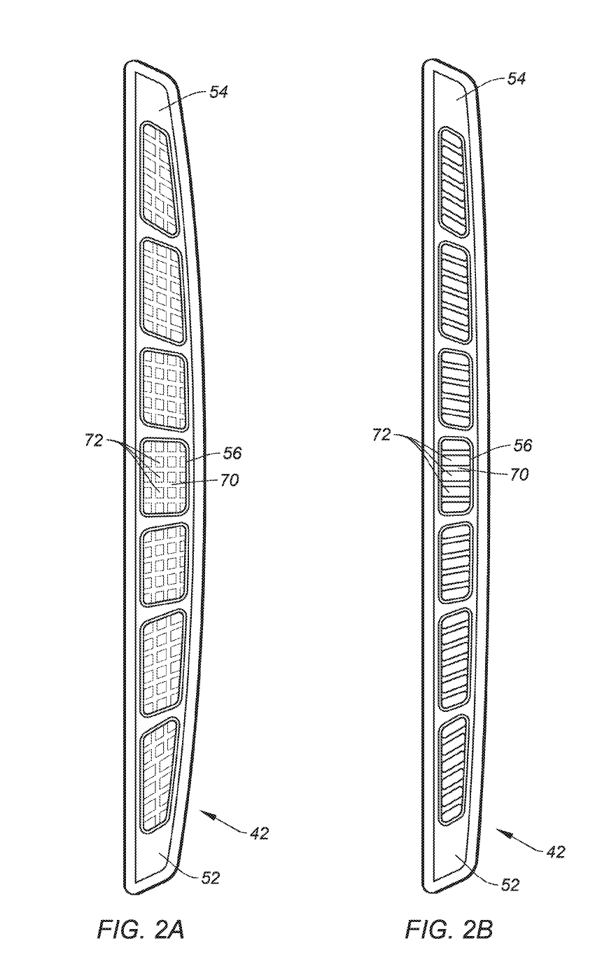

Referring to FIGS. 2A and 2B, plan views are shown of lubrication box bodies 42 with respective support structures 70, but with any shaving aid material omitted (for the purposes of clarity of illustration). In FIG. 2A the support structure apertures 72 comprise a vertically and horizontally arranged array (relative to a length and width of the box body). In FIG. 2B the support structure apertures comprise a row of slits extending across the upper wall aperture 56.

The shaving aid material 80 preferably includes 100% water soluble shaving aid materials, although traces of ingredients such as colorants, perfumes and/or skin-beneficial agents such as vitamin E or aloe are acceptable. The preferred shaving aid material is a lubricous water-soluble polymer and more preferably is polyethylene oxide. A range of suitable polyethylene oxide materials is sold under the trade name POLYOX by the Dow Company and other manufacturer's materials are also available. The more preferred polyethylene oxides preferably have molecular weights of about 100,000 to 8 million (based on rheological methods), most preferably about 300,000 to 5 million. The most preferred polyethylene oxide comprises a blend of about 40 to 80% of polyethylene oxide having an average molecular weight of about 5 million and about 20 to 60% of polyethylene oxide having an average molecular weight of about 300,000.

The polyethylene oxide (blend) can also advantageously contain (water soluble) plasticizers. The use of the plasticizers allows the utilization of substantially lower temperatures during the time of processing to produce a flowability of the polyethylene oxide during ultrasonic compressing without substantially reducing its molecular weight. Preferred plasticizers are polyethylene glycol particularly with molecular weight between 400 and 20,000, water soluble polypropylene glycol particularly with molecular weight between 400 and 4,000, water-soluble copolymers of ethylene and propylene oxide, water-soluble alkyl phenol ethoxylates, glycerine, sorbitol and water. Particularly preferred plasticizers are propylene glycol and octyl phenol ethoxylate with 9 moles of ethylene oxide.

Multiple layers of shaving aid material can be employed. In some embodiments, a designer can choose to have the multiple layers included in the lubrication box 40 be generally the same, if not identical, in amount and/or chemical composition. However, a designer can prefer that a second layer 82 be different than a first layer 84 in one or more aspects. For example, a second layer 82 can be designed such that it is a different in amount, chemical composition (e.g. molecular weight), and/or color than a previous layer. Such a change could be used to provide a varied shaving benefit to the user and/or notify a user that, for example, the lubrication box 40 has almost reached its usable lifespan.

The lid 44 of the lubrication box 40, as shown in FIGS. 3A-3C and 4, is affixed to the body 42 of the lubrication box 40, substantially encasing the shaving aid material 80 therein. The lid 44 can be of any suitable shape and size, provided that the lid 44 substantially covers the open end of the cavity 60. In addition, the lid 44 is preferably shaped such that a gap 62 (see FIG. 4) exists between the shaving aid material 80 and an inner surface of the lid 44. The gap 62 provides space for the shaving aid material 80 to expand when wetted. In some cases, a small vent 66 through the sidewall 58 and/or lid 44 (see FIG. 3A) can assist to alleviate the build-up of excessive pressure inside the lubrication box 40 due to such expansion.

The lid 44 can be made from any suitable material, however, it is preferable for the material to be compatible with the attachment method used to join the lid 44 to the body 42. The lid 44 can be attached to the body 42 in any suitable manner. For example, ultrasonically welding the lid 44 to the body 42 has been shown to have particular utility when, for example, the two portions of the lubrication box are made from thermoplastic materials. However, the present disclosure is not so limited, and the two portions of the lubrication box can be glued or otherwise bonded together. In addition, in some embodiments, a physical connection (e.g., male/female connectors, press fit) is suitable.

One method of making the lubrication box 40 of the present disclosure includes, first, providing a body 42 of the lubrication box 40. The body 40 of the lubrication box 42 can be made of any suitable material by any known means (e.g., molding a thermoplastic body 42 of the lubrication box 40). The body 42 is placed in a support nest and an amount (e.g. a first amount) of shaving aid material in solid particulate form is distributed in the cavity 60. Once the shaving aid is distributed a piston then applies pressure one or more times, and provides an amount of ultrasonic energy (e.g., via an ultrasonic horn). The pressure of the piston and the ultrasonic energy act to ultrasonically compact the shaving aid into a body of shaving aid material 80. Further details of this compaction process are disclosed in U.S. Patent application publications 2011/0099815 and 2012/0023750, the content of which is incorporated herein for reference to compaction methods. The present disclosure is not limited to the method of compacting the shaving aid material and other methods can be employed. For example the compaction can also be performed by a pure mechanical force, i.e. without ultrasonic energy.

A second amount of shaving aid can optionally be distributed into the cavity 60. The compaction process is repeated to provide a second layer 82 next to a first layer 84. Further optional layers can also be added,

Once the shaving aid material 80 is suitably compacted and optionally layered within the body 42 of the lubrication box 40, the lid 44 is placed on the opening of the cavity 60 and affixed. The lubrication box 108 is then affixed, directly or indirectly, to the frame 22 of the razor cartridge 20 such that the skin-engaging surface 54 would be generally in contact with the user's skin during normal shaving.

Although the disclosure has been described and illustrated with reference to specific illustrative embodiments thereof, it is not intended that the disclosure be limited to those illustrative embodiments. Those skilled in the art will recognize that variations and modifications can be made without departing from the true scope of the disclosure as defined by the claims that follow. For instance, features disclosed in connection with any one embodiment can be used alone or in combination with each feature of the respective other embodiments.

What is claimed is:

1. A lubrication box for a shaving cartridge, comprising:
an upper wall of a body of the lubrication box, the upper wall having a skin-engaging surface and an upper wall aperture, and at least one sidewall depending from the upper wall, the upper wall and the at least one sidewall forming a cavity;
a support structure disposed within the cavity, the support structure comprising a plurality of support structure apertures that one of directly and indirectly extend from the upper wall aperture;
a solid shaving aid material disposed within the cavity, the shaving aid material at least partially filling the upper wall aperture and the support structure apertures; and
a lid of the lubrication box, the lid being attached to the sidewall such that the cavity is substantially closed.

2. The lubrication box of claim 1, wherein a gap exists between in the cavity between the shaving aid material and the lid of the lubrication box to permit the shaving aid material to expand during normal use.

3. The lubrication box of claim 1, wherein the body of the lubrication box and the support structure are integrally formed.

4. The lubrication box of claim 3, wherein the support structure apertures extend directly from, and are aligned with the outer wall aperture.

5. The lubrication box of claim 1, wherein the body of the lubrication box and the support structure are separate structures.

6. The lubrication box of claim 5, wherein the support structure is in contact with an interior surface of the upper surface, opposed the skin-engaging surface, such that the support structure apertures extend directly from the upper wall aperture.

7. The lubrication box of claim 6, wherein the support structure apertures are aligned with the upper wall aperture.

8. The lubrication box of claim 6, wherein the support structure apertures are angled relative to the upper wall aperture.

9. The lubrication box of claim 1, wherein the body of the lubrication box and the support structure are separate structures and wherein the support structure is spaced from the interior surface of the upper surface such that the support structure apertures extend indirectly from the upper wall aperture.

10. The lubrication box of claim 1, wherein the shaving aid material consists essentially of polyethylene oxide.

11. The lubrication box of claim 1, wherein the shaving aid material comprises a first layer and a second layer.

12. The lubrication box of claim 9, wherein the shaving aid material comprises two layers and a first layer of the shaving aid material at least partially fills the upper wall aperture and a second layer of the shaving aid material at least partially fills the support structure apertures.

13. The lubrication box of claim 11, wherein the first layer and second layer of shaving aid material have substantially the same chemical composition.

14. The lubrication box of claim 11, wherein the first layer and second layer of shaving aid material have different chemical compositions.
